(19) United States
(12) Patent Application Publication
(10) Pub. No.: US 2003/0055859 A1
(43) Pub. Date: Mar. 20, 2003

(54) Fast IEEE floating-point adder

(75) Inventors: Peter-Michael Seidel, Dallas, TX (US); Guy Even, Tel-Aviv (IL)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Southern Methodist University, Dallas, TX

(21) Appl. No.: 10/138,659

(22) Filed: May 6, 2002

Related U.S. Application Data
(60) Provisional application No. 60/288,430, filed on May 4, 2001.

(51) Int. Cl. G06F 7/42

(52) U.S. Cl. 708/505

(57) ABSTRACT

An IEEE floating-point adder (FP-adder) design. The adder accepts normalized numbers, supports all four IEEE rounding modes, and outputs the correctly normalized rounded sum/difference in the format required by the IEEE Standard. The latency of the design for double precision is roughly 24 logic levels, not including delays of latches between pipeline stages. Moreover, the design can be easily partitioned into two stages comprised of twelve logic levels each, and hence, can be used with clock periods that allow for twelve logic levels between latches. The FP-adder design achieves a low latency by combining various optimization techniques, including a non-standard separation into two paths, a simple rounding algorithm, unifying rounding cases for addition and subtraction, sign-magnitude computation of a difference based on one's complement subtraction, compound adders, and fast circuits for approximate counting of leading zeros from borrow-save representation. A comparison of the design with other implementations suggests a reduction in the latency by at least two logic levels as well as simplified rounding implementation. A reduced precision version of the FP adder has been verified by exhaustive testing.

### CROSS-REFERENCE TO RELATED APPLICATION

The present application claims priority to U.S. Provisional Patent Application No. 60/288,430, filed May 4, 2001, the entire contents of which are incorporated herein by reference.

### BACKGROUND OF THE INVENTION

### FIELD OF THE INVENTION

The present invention relates generally to systems and methods for performing fast floating-point addition and subtraction using a floating-point (FP) adder.

The present invention also generally relates to techniques for performing floating point arithmetic, for example, as disclosed in one or more of U.S. Pat. Nos. 5,790,445; 4,639,887; 5,808,926; 5,063,530; 5,931,896; 5,197,023; 5,136,536; 6,094,668; 5,027,308; 5,764,556; 5,684,729; all of which are incorporated herein by reference.

The present invention includes use of various technologies referenced and described in the above-noted U.S. Patents and Applications, as well as described in the references identified in the following LIST OF REFERENCES by the author(s) and year of publication and cross-referenced throughout the specification by reference to the respective number, in parentheses, of the reference:

### List of References

[1] S. Bar-Or, Y Levin, and G. Even, “On the delay overheads of the supporting denormal inputs and outputs in floating point adders and multipliers,” in preparation.

[2] S. Bar-Or, Y Levin, and G. Even, “Verification of scalable algonthms: case study of an IEEE floating point addition algorithm,” in preparation.

[3] A. Beaumont-Smith, N. Burgess, S. Lefrere, and C. C. Lim, “Reduced latency IEEE floating-point standard adder architectures,” Proc. 14th Symp. on Computer Arithmetic, 14, 1999.

[4] R. P. Brent and H. T. Kung, “A Regular Layout for Parallel Adders,” IEEE Trans. on Computers, C-31(3):260264, March 1982.

[5] M. Daumas and D. W. Matula, “Recoders for partial compression and rounding,” Technical Report RR97-O1, Ecole Normale Superieure de Lyon, LIP, 1996.

[6] L. E. Eisen, T. A. Elliott, R. T. Golla, and C. H. Olson, “Method and system for performing a high speed floating point add operation,” IBM Corporation, U.S. Pat. No. 5,790,445, 1998.

[7] G. Even and P. M. Seidel, “A comparison of three rounding algorithms for IEEE floating-point multiplication,” IEEE Transactions on Computers, Special Issue on Computer Arithmetic, pages 638-650, July 2000.

[8] P. M. Farmwald, “On the design of high performance digital arithmetic units,” Ph.D. thesis, Stanford Univ., August 1981.

[9] P. M. Farmwald, “Bifurcated method and apparatus for floating-point addition with decreased latency time,” U.S. Pat. No. 4,639,887, 1987.

[10] V Y Gorshtein, A. I. Grushin, and S. R. Shevtsov, “Floating point addition methods and apparatus,” Sun Microsystems, U.S. Pat. No. 5,808,926, 1998.

[11] IEEE standard for binary floating point arithmetic, ANSI/IEEE754-1985.

[12] T. Ishikawa, “Method for adding/subtracting floating-point representation data and apparatus for the same,” Toshiba,K. K., U.S. Pat. No. 5,063,530, 1991.

[13] T. Kawaguchi, “Floating point addition and subtraction arithmetic circuit performing preprocessing of addition or subtraction operation rapidly,” NEC, U.S. Pat. No. 5,931,896, 1999.

[14] T. Nakayama, “Hardware arrangement for floating-point addition and subtraction,” NEC, U.S. Pat. No. 5,197,023, 1993.

[15] K. Y Ng, “Floating-point ALU with parallel paths,” Weitek Corporation, U.S. Pat. No. 5,136,536, 1992.

[16] A. M. Nielsen, D. W. Matula, C. N. Lyu, and G. Even, “IEEE compliant floating-point adder that confirms with the pipelined packet-forwarding paradigm,” IEEE Transactions on Computers, 49(1):33-47, January 2000.

[17] S. Oberman, “Floating-point arithmetic unit including an efficient close data path,” AMD, U.S. Pat. No. 6,094,668, 2000.

[18] S. F. Oberman, H. Al-Twaijry, and M. J. Flynn, “The SNAP project: Design of floating point arithmetic units,” In Proc. 13th IEEE Symp. on Comp. Arith., pages 156-165, 1997.

[19] W. C. Park, T. -D. Han, S. D. Kim, and S. B. Yang, “Floating Point Adder/Subtractor Performing IEEE Rounding and Addition/Subtraction in Parallel,” IEICE Transactions on Information and Systems, E79D(4):297-305, 1996.

[20] N. Quach and M. Flynn, “Design and implementation of the SNAP floating-point adder,” Technical Report CSL-TR-91-501, Stanford University, December 1991.

[21] N. Quach, N. Takagi, and M. Flynn, “On fast IEEE rounding,” Technical Report CSL-TR-91-459, Stanford, January 1991.

[22] P. M. Seidel, “On The Design of IEEE Compliant Floating-Point Units and Their Quantitative Analysis,” PhD thesis, University of the Saarland, Germany, December 1999.

[23] P. M. Seidel and G. Even, “How many logic levels does floating-point addition require?” In Proceedings of the 1998 International Conference on Computer Design (ICCD'98): VLSI in Computers & Processors, pages 142-149, October 1998.

[24] H. P. Sit, D. Galbi, and A. K. Chan, “Circuit for adding/subtracting two floating-point operands,” Intel, U.S. Pat. No. 5,027,308, 1991.

[25] D. Stiles, “Method and apparatus for performing floating-point addition,” AMD, U.S. Pat. No. 5,764,556, 1998.

[26] A. Tyagi, “A Reduced-Area Scheme for Carry-Select Adders,” IEEE Transactions on Computers, C-42(10), October 1993.

[27] H. Yamada, F. Murabayashi, T. Yamauchi, T. Hotta, H. Sawamoto, T. Nishiyama, Y. Kiyoshige, and N. Ido, “Floating-point addition/subtraction processing apparatus and method thereof,” Hitachi, U.S. Pat. No. 5,684,729, 1997.

The entire contents of each related patent and application listed above and each reference listed in the LIST OF REFERENCES, are incorporated herein by reference.

### DISCUSSION OF THE BACKGROUND

Floating-point addition and subtraction are the most frequent floating-point operations. Both operations use a floating point (FP) adder. Thus, much effort has been spent on reducing the latency of FP adders (see [3, 8, 16, 18, 19, 20, 21, 22, and 23]).

Notation

Binary strings are denoted in upper case letters (e.g. S,E,F). The value represented by a binary string is represented in italics (e.g., s, e, f). In double precision, IEEE FP-numbers are represented by the three fields (S; E[10:0]; F[0:52]), with sign bit Sε{0, 1}, exponent string E[10:0]ε{0, 1}¹¹, and significand string F[0:52]ε{0, 1}⁵³. The values of exponent and significand are defined by:

$$e = {\sum }_{i = 0}^{10} E [ i ] \cdot {2}^{i} - 1023 , f = {\sum }_{i = 0}^{52} F [ i ] \cdot {2}^{- i} .$$

Since only normalized FP-numbers are considered, fε[1, 2). An FP-number (S, E[10:0]; F[0:52]) represents the value: fp_val(S, E, F)=(−1)^{S}·2^{e}·f as follows:

1. Sε{0, 1} denotes the sign bit.

2. E[10:0]ε{0, 1}¹¹ denotes the exponent string. The value represented by an exponent string E[10:0] that is not all zeros or all ones is

$$e = {\sum }_{i = 0}^{10} E [ i ] \cdot {2}^{i} - 1023$$

3. F[0:52]ε{0, 1}⁵³ denotes the significand string that represents a fraction in the range [1; 2) (denormalized numbers or zero are not handled here). When representing significands, the convention that bit positions to the right of the binary point have positive indices and bit positions to the left of the binary point have negative indices is used. Hence, the value represented by f[0:52] is

$$f = {\sum }_{i = 0}^{52} F [ i ] \cdot {2}^{- i}$$

The value represented by an FP-number (S; E[10:0]; f[0:52]) is

fp_val(S, E, F)=(−1)^{S}·2^{e}·f

Given an IEEE FP-number (S, E, F), the triple (s, e, f) is the factoring of the FP-number. Note that s=S since S is a single bit. The advantage of using factorings is the ability to ignore representation details and focus on values.

The inputs of an FP-addition/subtraction are (1) operands denoted by (SA, EA[ 10:0]; FA[0:52]) and (SB, EB[10:0]; FB[0:52]); (2) an operation SOPε{0, 1} where SOP=0 denotes addition and SOP=1 denotes subtraction; and (3) IEEE rounding mode.

The output is a FP-number (S, E[10:0]; F[0:52]). The value represented by the output equals the IEEE rounded value of

fpsum=fp_val(SA, EA[10:0], FA[0:52])+(−1)^{SOP}fp_val(SB, EB[10:0]; FB[0:52])

During FP-addition, the significands of the operands are aligned, negated, pre-shifted, etc. Letters are appended to signals to indicate the manipulations that take place and the source of the signal as follows:

1. FS denotes the significand string of the “smaller” operand.

2. FL denotes the significand string of the “larger” operand.

3. An “O” denotes the one's complement negation (e.g. FAO denotes the string obtained by the inversion of all the bits of FA).

4. A “P” denotes a pre-shift by one position to the left. This shift takes place in effective subtraction.

5. An apostrophe (') denotes a shift by one position to the right (i.e., division by 2). This shift takes place in the case of a positive large exponent difference to compensate for the one's complement subtraction of the exponents.

6. An “A” denotes the alignment of the significand (e.g., FSOA is the outcome of aligning FSO).

The following symbols are used as prefixes to indicate the meaning of the signals:

1. The prefix “abs” means the “absolute value.” (e.g. abs_FSUM is the absolute value of FSUM).

2. The prefix “fixed” means that the LSB of the significand has been fixed to deal with the discrepancy between round-to-nearest-even (RNE) and round-to-nearest-up (RNU)

3. The prefix “r” means “rounded.”

4. The prefix “norm,” when applied to a significand, means that the significand is normalized to the range [1; 4).

5. The prefix “ps,” when applied to a significand, means that the significand is post-normalized to the range [1; 2).

Naive Floating Point Adder Algorithm

An overview of a naive FP-addition algorithm is now presented. To simplify the notation, the representation is ignored and only the values of the inputs, outputs, and intermediate results are discussed. The notation used for the naive algorithm will also be used in the description of the FP-adder of the present invention below.

Let (sa, ea, fa) and (sb, eb, fb) denote the factorings of the operands with a sign-bit, an exponent, and a significand, and let SOP indicate whether the operation is an addition or a subtraction. The requested computation is the IEEE FP representation of the rounded sum:

rnd(sum)=rnd((−1)^{sa}·2^{ea}·fa+(−1)^{SOP+sb}·2^{eb}·fb).

Let S.EFF=sa ⊕ sb ⊕ SOP. The case that S.EFF=0 is called effective addition and the case that S.EFF=1 is called effective subtraction.

The exponent difference is defined as δ=ea−eb. The “large” operand, (sl, el, fl), and the “small” operand, (ss, es, fs), are defined as follows:

$$( sl , el , fl ) = \{ \begin{matrix}( sa , ea , fa ) & if δ \geq 0 \\ ( SOP ⊕ sb , eb , fb ) & otherwise\end{matrix} \\ ( ss , es , fs ) = \{ \begin{matrix}( SOP ⊕ sb , eb , fb ) & if δ \geq 0 \\ ( sa , ea , fa ) & otherwise\end{matrix}$$

The sum can be written as

sum=(−1)^{sl}·2^{el}·(fl+(−1)^{S.EFF}(fs·2^{-|δ|})).

To simplify the description of the datapaths, consider the computation of the result's significand, which is assumed to be normalized (i.e., in the range [1, 2)). The significand sum is defined by

fsum=fl+(−1)^{S.EFF}(fs·2^{-|δ|}).

The significand sum is computed, normalized, and rounded as follows:

1. exponent subtraction δ=ea−eb,

2. operand swapping (compute sl,el fl, and fs),

3. limitation of the alignment shift amount: δ_lim=min {α, abs(δ)}, where α is a constant greater than or equal to 55,

4. alignment shift of fs: fsa=fs·2^{-δ}^{_{—}}^{lim},

5. significand negation: fsan=(−1)^{S.EFF} fsa,

6. significand addition: fsum=fl+fsan,

7. conversion abs_fsum=abs(fsum), S=sl⊕ (fsum<0),

8. normalization n_fsum=norm(abs_fsum),

9. rounding and post-normalization of n_fsum.

The naive FP-adder implements the nine steps above sequentially, where the delay of steps 4 and 6-9 is logarithmic in the significand's length. Therefore, this is a slow FP-adder implementation.

### SUMMARY OF THE INVENTION

Accordingly, it is an object of the present invention to provide a method and apparatus for performing floating point addition and subtraction.

The above and other objects are achieved according to the present invention by providing an FP-adder that accepts normalized double precision significands, supports all IEEE rounding modes, and outputs the normalized sum/difference that is rounded according to the IEEE FP standard 754 [11]. The latency of the design is analyzed in technology-independent terms (i.e., logic levels) to facilitate comparisons with other designs. The latency of the design for double precision is roughly 24 logic levels, not including delays of latches between pipeline stages. The design is amenable to pipelining with short clock periods; in particular, it can be easily partitioned into two stages consisting of 12 logic levels each. Additions to the design that address denormal inputs and outputs are discussed in references [1] and [22]. It is shown that the delay overhead for supporting denormal numbers can be reduced to 1-2 logic levels.

An important aspect of the present invention is the use of several optimization techniques. A detailed examination of these techniques demonstrates how these techniques can be combined to achieve an overall fast FP-adder design. In particular, effective reduction of latency by parallel paths requires balancing the delay of the paths. This balance is achieved by a gate-level consideration of the design. The optimization techniques used include a two path design with a non-standard separation criterion. Instead of separation based on the magnitude of the exponent difference [9], a separation criterion is defined that also considers (1) whether the operation is effective subtraction, and (2) the value of the significand difference. This separation criterion maintains the advantages of the standard two-path designs, namely, that alignment shift and normalization shift take place only in one of the paths, and the full exponent difference is computed only in one path. In addition, this separation technique requires rounding to take place only in one path.

Additional optimization techniques include a reduction of rounding modes and injection-based rounding. In addition, the IEEE rounding modes are reduced to three modes [21], and injection-based rounding is employed in the rounding circuitry [7]. Further optimization features of the present invention include: (1) a simpler design obtained by using unconditional pre-shifts for effective subtractions, to reduce to two the number of binades that the significand sum and difference could belong to; (2) one's complement representation to compute the sign-magnitude representation of the difference of the exponents and the significands; (3) a parallel-prefix adder to compute the sum and the incremented sum of the significands [26]; (4) recodings to estimate the number of leading zeros in the non-redundant representation of a number represented as a borrow-save number [16]; and (5) advanced computation of the post-normalization (before the rounding decision is ready), due to the latency of the rounding decision signal.

To relate the proposed implementation to previous FP-adder designs, an overview of other FP-adder implementations, and a summary of the optimization techniques used in each of these designs, is given. An analysis of two particular implementations is given in some detail [10], [17]. To allow for a “fair” comparison, the functionality of these designs were adopted to match the functionality of the present design. A comparison of these designs with the present design suggests that the present design is faster by at least 2 logic levels. In addition, the present design uses simpler rounding circuitry and is more amenable to partitioning into two pipeline stages of equal latency, or even into four very short pipeline stages.

This present invention relates to double precision FP-adder implementations. Many FP-adders support multiple precisions (e.g., ×86 architectures support single, double, and extended double precision). It has been shown that by aligning the rounding position (i.e., 23 positions to the right of the binary point in single precision and 52 positions to the right of the binary point in double precision) of the significands before they are input to the design and postaligning the outcome of the FP-adder, it is possible to use the FP-adder of the present invention for multiple precisions [22]. Hence, the FP-addition algorithm presented here can be used to support multiple precisions.

The correctness of the present FP-adder design was verified by conducting exhaustive testing on a reduced precision version. (See [2].)

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an implementation of the one's complement box annotated with timing estimates;

FIG. 2 is a high level structure of the new FP addition algorithm in which a vertical dashed line separates two pipelines (R-path and N-path), and a horizontal dashed line separates the two pipeline stages;

FIGS. 3A and 3B show a block diagram of R-path;

FIG. 4 is a block diagram of the N-path;

FIGS. 5A and 5B show a detailed block diagram of the 1^{st} clock cycle of the R-path annotated with timing estimates (“5LL” next to a signal means that the signal is valid after five logic levels);

FIGS. 6A and 6B show a detailed block diagram of the 2^{nd} clock cycle of the R-path annotated with timing estimates;

FIGS. 7A and 7B show a detailed block diagram of the N-path annotated with timing estimates;

FIGS. 8A and 8B show a block diagram of the AMD patent FP-adder implementation adapted to accept double precision operands and to implement all 4 IEEE rounding modes; and

FIGS. 9A and 9B show a block diagram of the SUN patent FP-adder implementation adapted to work only on unpacked normalized double precision operands and to implement all 4 IEEE rounding modes.

### DESCRIPTION OF THE PREFERRED EMBODIMENT

### Optimization Technique

The FP-adder pipeline is separated into two parallel paths that work under different assumptions. The partitioning into two parallel paths enables one to optimize each path separately by simplifying and skipping some of the steps of the naive addition algorithm. Such a dual path approach for FP-addition was first described by Farmwald [8]. Since Farmwald's dual path FP-addition algorithm, the common criterion for partitioning the computation into two paths has been the exponent difference. The exponent difference criterion is defined as follows: the near path is defined for small exponent differences (i.e.,−1, 0, +1), and the far path is defined for the remaining cases.

Different partitioning criterion for partitioning the algorithm into two paths is used: the N-path for the computation of all effective subtractions with small significand sums fsumε(-1,1) and small exponent differences |δ|≦1, and the R-path for all the remaining cases. The path selection signal IS_R is defined as follows:

IS_{—R \overline{S.EFF} OR |δ|≧} [symbol]2 OR fsum ε [1,2). (1)

The outcome of the R-path is selected for the final result if IS_R=1, otherwise the outcome of the N-path is selected. This partitioning has the following advantages:

1. In the R-path, the normalization shift is limited to a shift by one position (the normalization shift may be restricted to one direction, as discussed below). Moreover, the addition or subtraction of the significands in the R-path always results in a positive significand, and therefore, the conversion step can be skipped.

2. In the N-path, the alignment shift is limited to a shift by one position to the right. Under the assumptions of the N-path, the exponent difference is in the range {−1, 0,1}. Therefore, a 2-bit subtraction suffices for extracting the exponent difference. Moreover, in the N-path, the significand difference can be exactly represented with 53 bits, hence, no rounding is required.

Note that the N-path applies only to effective subtractions in which the significand difference fsum is less than 1. Thus, in the N-path, it is assumed that fsumε(−1,1).

The advantages of the partitioning criterion compared to the exponent difference criterion stem from the following two observations: (1) a conventional implementation of a far path can also be used to implement the R-path; and (2) the N-path is simpler than the near path since no rounding is required and the N-path applies only to effective subtractions. Hence, the N-path is implemented simpler and faster.

In the R-path, the range of the resulting significand is different in effective addition and effective subtraction. In effective addition, flε[1, 2) and fsanε[0, 2). Therefore, fsumε[1, 4). It follows from the definition of the path selection condition that in effective subtractions fsumε(½, 2) in the R-path. The ranges of fsum are unified in these two cases to [1, 4) by multiplying the significands by 2 in the case of effective subtraction (i.e., pre-shifting by one position to the left). The unification of the range of the significand sum in effective subtraction and effective addition simplifies the rounding circuitry. To simplify the notation and the implementation of the path selection condition the operands are also pre-shifted for effective subtractions in the N-path. Note, that in this way the pre-shift is computed in the N-path unconditionally, because in the N-path all operations are effective subtractions. In the following, a few examples of values that include the conditional pre-shift (note that an additional “p” is included in the names of the pre-shifted versions) are given:

$$flp = \{ \begin{matrix}2 \cdot fl & if S . EFF \\ fl & otherwise\end{matrix} \\ fspan = \{ \begin{matrix}2 \cdot fsan & if S . EFF \\ fsan & otherwise\end{matrix} \\ fpsum = \{ \begin{matrix}2 \cdot fsum & if S . EFF \\ fsum & otherwise\end{matrix}$$

Note, that based on the significand sum fpsum, which includes the conditional pre-shift, the path selection condition can be rewritten as:

IS_{—R \overline{S.EFF} OR |δ|≧} [symbol]2 OR fpsumε[2,4). (2)

The IEEE-754-1985 Standard defines four rounding modes: round toward 0, round toward +∞, round toward −∞, and round-to-nearest (even) [11]. The four IEEE rounding modes can be reduced to three rounding modes: round-to-zero RZ, round-to-infinity RI, and round-to-nearest-up RNU [21]. The discrepancy between round-to-nearest-even and RNU is fixed by pulling down the LSB of the fraction [7]. In the rounding implementation in the R-path, the three rounding modes RZ, RNU, and RI are further reduced to truncation using injection based rounding [7]. The reduction is based on adding an injection that depends only on the rounding mode. Let X=X₀.X₁X₂ . . . Xₖ denote the binary representation of a significand with the value x=|X|ε[1, 2) for which k≧53 (double precision rounding is trivial for k<53), then the injection is defined by:

$$INJ = \{ \begin{matrix}0 & & if RZ \\ {2}^{- 53} & & if RNU \\ {2}^{- 52} & - {2}^{- k} & if RI\end{matrix}$$

For double precision and modeε{RZ, RNU, RI}, the effect of adding INJ is summarized in the following equation:

|X|ε[1, 2) [symbol] rnd_{mode}(|X|)=rnd_{RZ}(|X|)+I NJ). (3)

In this technique, the sign-magnitude computation of a difference is computed using one's complement representation [18]. This technique is applied in two situations:

1. Exponent difference. The sign-magnitude representation of the exponent difference is used for two purposes: (1) the sign determines which operand is selected as the “large” operand; and (2) the magnitude determines the amount of the alignment shift.

2. Significand difference. In case the exponent difference is zero and an effective subtraction takes place, the significand difference might be negative. The sign of the significand difference is used to update the sign of the result and the magnitude is normalized to become the result's significand.

Let A and B denote binary strings and let |A| denote the value represented by A (i.e., |A|=ΣᵢA [i]−2ⁱ). The technique is based on the following observation:

$$abs ( \vert A \vert - \vert B \vert ) = \{ \begin{matrix}\vert A \vert + \vert \overline{B} \vert + 1 & if \vert A \vert - \vert B \vert > 0 \\ \vert \overline{A \vert + \vert \overline{B} \vert} & if \vert A \vert - \vert B \vert \leq 0\end{matrix}$$

The actual computation proceeds as follows: The binary string D is computed such that |D|=|A|+|\overline{B}|. D is referred to as the one's complement lazy difference of A and B. Consider two cases:

1. If the difference is positive, then |D| is off by an ulp and |D| must be incremented. However, to save delay, the increment is avoided as follows: (a) In the case of the exponent difference that determines the amount of the alignment shift, the significands are pre-shifted by one position to compensate for the error. (b) In the case of the significand difference, the missing ulp is provided by computing the incremented sum of |A| and |B| using a compound adder.

2. If the exponent difference is negative, then the bits of D are negated to obtain an exact representation of the magnitude of the difference.

The technique of computing in parallel the sum of the significands as well as the incremented sum is well known. The rounding decision controls which of the sums is selected for the final result, thus enabling the computation of the sum and the rounding decision in parallel.

The technique for implementing a compound adder is based on a parallel prefix adder in which the carry-generate and carry-propagate strings, denoted by Gen_C and Prop_C, are computed [4], [26]. Let Gen_C[i] equal the carry bit that is fed to position i. The bits of the sum S of the addends A and B are obtained as usual by:

S[i]=xor(A[i], B[i], Gen_{—}C[i]).

The bits of the incremented sum SI are obtained by:

SI[i]=xor(A[i], B[i], or(Gen_{—}C[i], Prop₁₃C[i])).

There are two instances of a compound adder in the preferred FP-addition algorithm. One instance appears in the second pipeline stage of the R-path where the delay analysis relies on the assumption that the MSB of the sum is valid one logic level prior to the slowest sum bit.

The second instance of a compound adder appears in the N-path. In this case, the problem that the compound adder does not “fit” in the first pipeline stage according to the delay analysis is also addressed. The critical path is broken by partitioning the compound adder between the first and second pipeline stages as follows. A parallel prefix adder placed in the first pipeline stage computes the carry-generate and carry-propagate signals as well as the bitwise xor of the addends. From these three binary strings the sum and incremented sum are computed within two logic levels as described above. However, these two logic levels must belong to different pipeline stages. Therefore the three binary strings S[i], P[i]=A[i] xor B[i] and GP_C[i]=or(Gen_C[i], Prop_C[i]) are first computed and then passed to the second pipeline stage. In this way the computation of the sum is already completed in the first pipeline stage and only an xor-line is required in the second pipeline stage to compute also the incremented sum.

In the N-path, a resulting significand in the range (−1,1) must be normalized. The amount of the normalization shift is determined by approximating the number of leading zeros. The number of leading zeros is approximated so that a normalization shift by this amount yields a significand in the range [1, 4). The final normalization is then performed by post-normalization. There are various other known implementations for the leading-zero approximation. The input used for counting leading zeros in the preferred design is a borrow-save representation of the difference. This design is amenable to partitioning into pipeline stages, and admits an elegant correctness proof that avoids a tedious case analysis.

The following technique for approximately counting the number of leading zeros is known [16]. The input consists of a borrow-save encoded digit string F[−1:52]ε{−1, 0,1}⁵⁴. The borrow-save encoded string F′[−2:52]=P(N(F[−1:52])) is computed, where P( ) and N( ) denote P-recoding and N-recoding [5], [16]. (P-recoding is like a “signed half-adder,” in which the carry output has a positive sign; N-recoding is similar, but has an output carry with a negative sign). The correctness of the technique is based on the following proposition.

Proposition 1. Suppose the borrow-save encoded string F′[−2:52] is of the form F′[−2:52]=O^{k}·σ·t[1:54-k], where · denotes concatenation of strings, O^{k} denotes a block of k zeros, σε{−1,1}, and tε{−1, 0,1}^{54-k}. Then the following holds:

(1) If σ=1, then the value represented by the borrow encoded string σ.t satisfies:

$$σ + {\sum }_{i = 1}^{54 - k} t [ i ] \cdot {2}^{- i} ∈ ( \frac{1}{4} , 1 ) .$$

(2) If σ=−1, then the value represented by the borrow encoded string σ.t satisfies:

$$σ + {\sum }_{i = 1}^{54 - k} t [ i ] \cdot {2}^{- i} ∈ ( - \frac{3}{2} , \frac{1}{2} ) .$$

The implication of Proposition 1 is that after PN-recoding, the number of leading zeros in the borrow-save encoded string F′[−2:53] (denoted by k in the proposition) can be used as the normalization shift amount to bring the normalized result into one of two binades (i.e., in the positive case either (1/4, 1/2) or [½, 1), and in the negative case after negation, either (½, 1) or [1 3/2)).

This technique was implemented so that the normalized significand is in the range (1, 4) as follows:

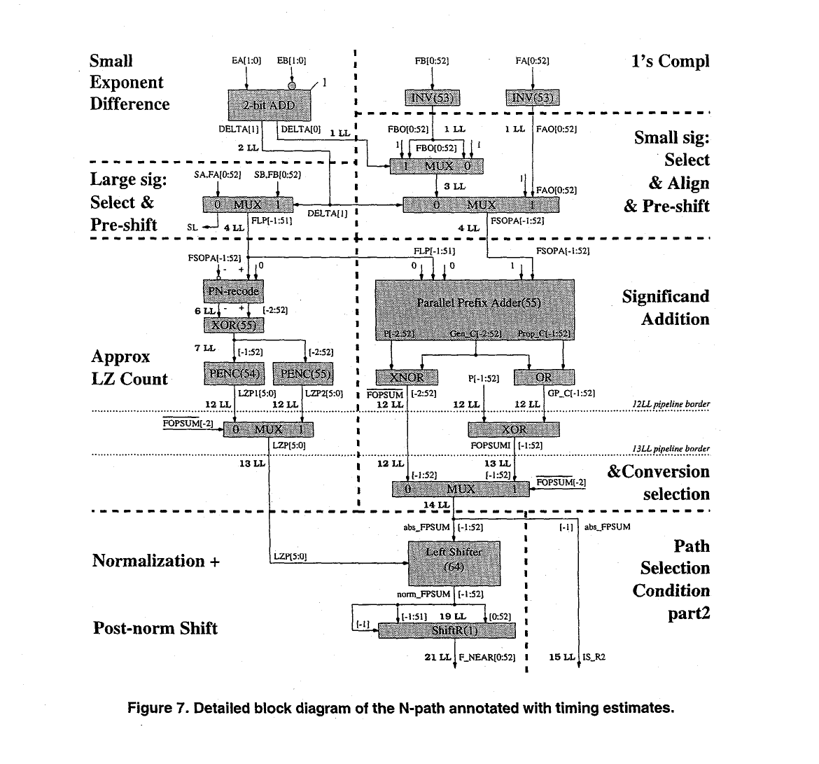

(1) In the positive case, the shift amount is lz2=k=lzero(F′(−2:52]). (See signal LZP2[5:0] in FIGS. 7A and 7B).

(2) In the negative case, the shift amount is lz1=k−1=lzero(F′[−1:52]). (See signal LZP1[5:0] in FIGS. 7A and 7B).

In the R-path, two choices for the rounded significand sum are computed by the compound adder. Either the “sum” or the “incremented sum” output of the compound adder is chosen for the rounded result. Because the significand after the rounding selection is in the range (1, 4) (due to the pre-shifts only these two binades have to be considered for rounding and for the post-normalization shift), post-normalization requires at most a right-shift by one bit position. Because the outputs of the compound adder have to wait for the computation of the rounding decision (selection based on the range of the sum output), the postnormalization shift on both outputs of the compound adder are precomputed before the rounding selection, so that the rounding selection already outputs the normalized significand result of the R-path.

### Preferred FP Adder Implementation

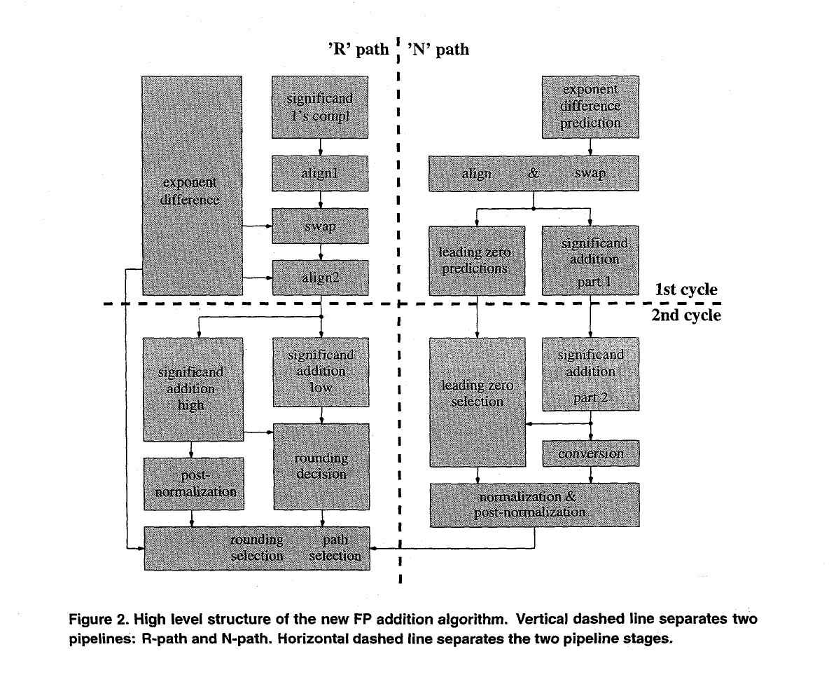

The partitioning of the design, which implements and integrates the optimization techniques discussed above is now described. The algorithm is a dual path two-staged pipeline partitioned into the R-path and the N-path. The final result is selected between the outcomes of the two paths based on the signal IS_R (see equation 2). A high-level block diagram of algorithm is shown in FIG. 2. An overview of the two paths is given in the following.

The R-path works under the assumption that (1) an effective addition takes place; or (2) an effective subtraction with a significand difference (after pre-shifting) greater than or equal to 2 takes place; or (3) the absolute value of the exponent difference |δ| is larger than or equal to 2. Note that these assumptions imply that the sign-bit of the sum equals SL.

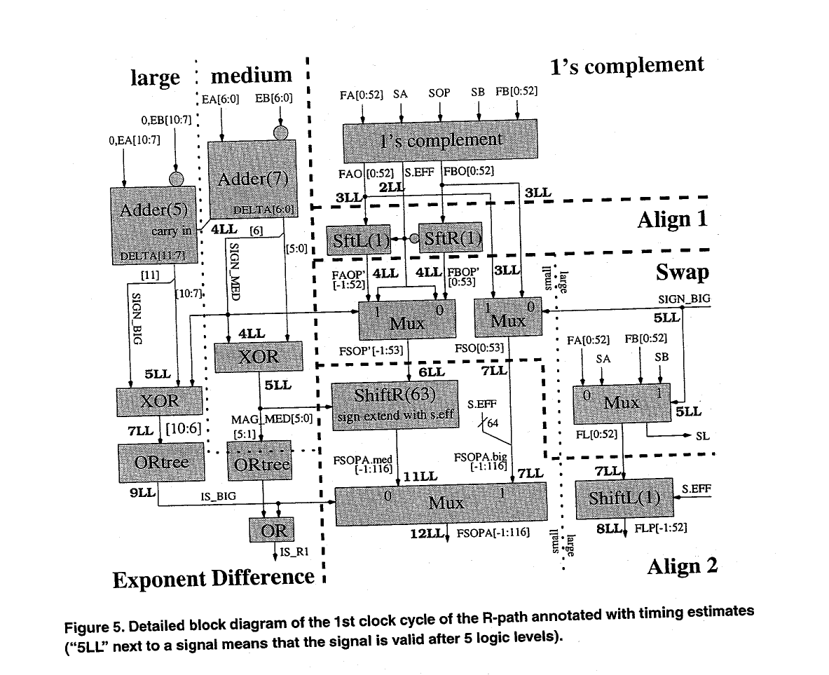

The R-path is divided into two pipeline stages. Loosely speaking, in the first pipeline stage, the exponent difference is computed, the significands are swapped and pre-shifted if an effective subtraction takes place, and the subtrahend is negated and aligned. In the Significand One's Complement box, the significand to become the subtrahend is negated (recall that one's complement representation is used). In the Align 1 box, the significand to become the subtrahend is (1) pre-shifted to the right if an effective subtraction takes place; and (2) aligned to the left by one position if the exponent difference is positive. This alignment by one position compensates for the error in the computation of the exponent difference when the difference is positive due to the one's complement representation. In the Swap box, the significands are swapped according to the sign of the exponent difference. In the Align 2 box, the subtrahend is aligned according to the computed exponent difference. The exponent difference box computes the swap decision and signals for the alignment shift. This box is further partitioned into two paths for medium and large exponent differences. A detailed block diagram for the implementation of the first cycle of the R-path is depicted in FIGS. 5A and 5B.

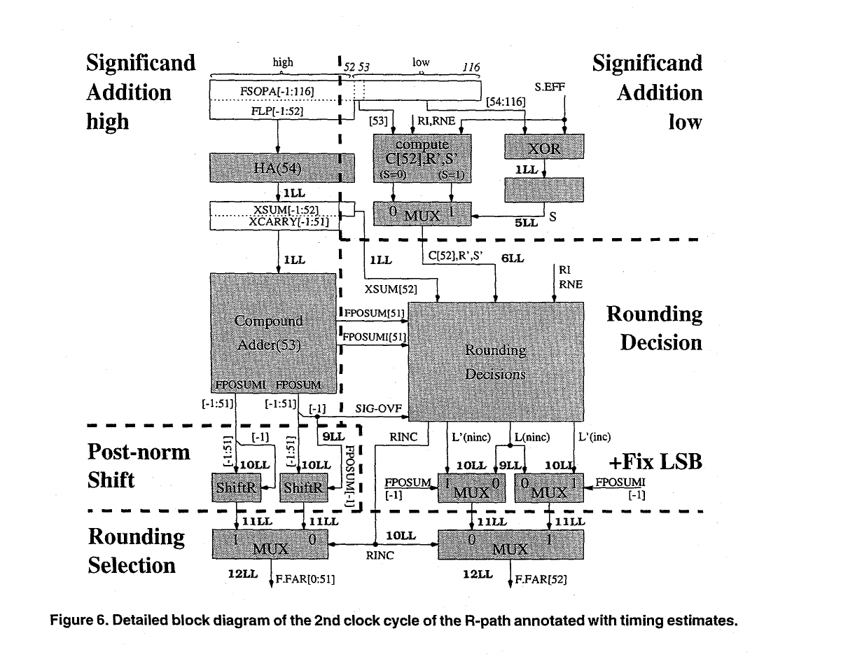

The input to the second pipeline stage consists of the significand of the “larger” operand and the aligned significand of the “smaller” operand, which is inverted for effective subtractions. The goal is to compute their sum and round it while taking into account the error due to the one's complement representation for effective subtractions [7]. The significands are divided into a low part and a high part that are processed in parallel. The low part computes the LSB of the final result based on the low part and the range of the sum. The high part computes the rest of the final result (which is either the sum or the incremented sum of the high part). The outputs of the compound adder are post-normalized before the rounding selection is performed. A detailed block diagram for the implementation of the second cycle of the R-path is depicted in FIGS. 6A and 6B.

The N-path works under the assumption that an effective subtraction takes place, the significand difference (after the swapping of the addends and pre-shifting) is less that 2 and the absolute value of the exponent difference |δ| is less than 2. The N-path has the following properties:

1. The exponent difference must be in the set {−1, 0,1}. Hence, the exponent difference can be computed by subtracting the two LSBs of the exponent strings. The alignment shift is by at most one position. This is implemented in the exponent difference prediction box.

2. An effective subtraction takes place, hence, the significand corresponding to the subtrahend is always negated. One's complement representation is used for the negated subtrahend.

3. The significand difference (after swapping and pre-shifting) is in the range (−2, 2) and can be exactly represented using 52 bits to the right of the binary point. Hence, no rounding is required.

Based on the exponent difference prediction the significands are swapped and aligned by at most one bit position in the align and swap box. The leading zero approximation and the significand difference are then computed in parallel. The result of the leading zero approximation is selected based on the sign of the significand difference in the leading zero selection box. The conversion box computes the absolute value of the difference and the normalization & post-normalization boxes normalizes the absolute significand difference as a result of the N-path. FIGS. 7A and 7B depict a detailed block diagram of the N-path.

The computations in the two computation paths are described separately for the 1st stage and for the 2nd stage of the R-path and for the N-path.

The computation performed by the first pipeline stage in the R-path outputs the significands flp and fsopa, represented by FLP[−1:52] and FSOPA[−1:116]. The significands flp and fsopa are defined by:

$$flp , fsopa ) = \{ \begin{matrix}( fl , fsan ) & if S . EFF = 0 \\ ( 2 \cdot fl , 2 \cdot fsan - {2}^{- 116} ) & otherwise .\end{matrix}$$

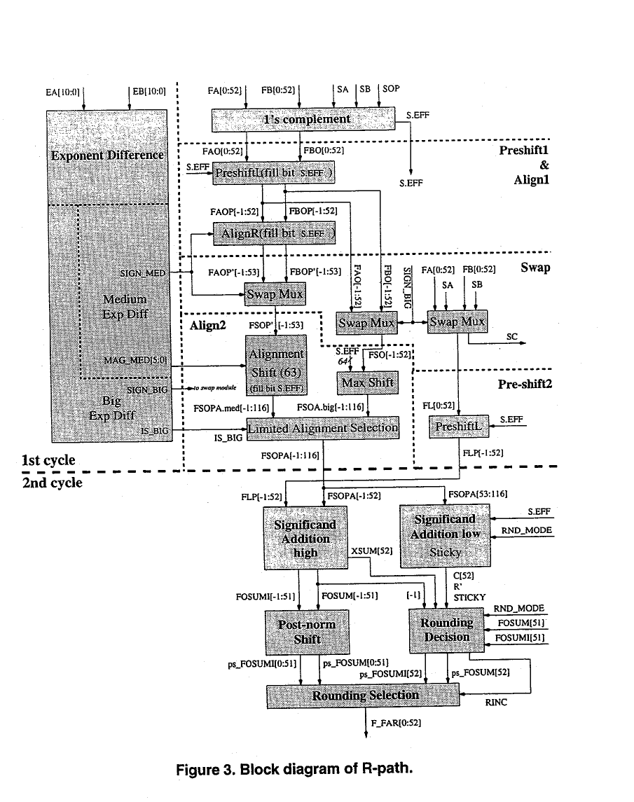

FIG. 3A and 3B depicts how the computations of FLP [−1:52] and FSOPA [−1:116] are performed. For each box in FIG. 2, a region surrounded by dashed lines is depicted to assist the reader in matching the regions with blocks.

1. The exponent difference is computed for two ranges: The medium exponent difference interval is [−63, 64], and the big exponent difference intervals consist of(−∞, −64] and [65, ∞]. The outputs of the exponent difference box are specified as follows. Loosely

$${( - 1 )}^{SIGN\_MED} \cdot ⟨ MAG\_MED ⟩ = \{ \begin{matrix}≅ - 1 & if 64 \geq δ \geq 1 \\ δ & if 0 \geq δ \geq - 63 \\ \text{"don't-care"} & otherwise\end{matrix}$$

speaking, the SIGN_MED and MAG_MED are the sign-magnitude representation of δ, if δ is in the medium exponent difference interval. Formally,

TABLE 1
Value of ESOP′ [−1:53] according to FIGS. 3A and 3B.

| | | pre-shift | align-shift | accumulated | |
|---|---|---|---|---|---|
| SIGN_MED | S.EFF | (left) | (right) | right shift | FSOP′ [−1:53] |
| 0 | 0 | 0 | 1 | 1 | (00, FBO[0:52]) |
| | 1 | 1 | 1 | 0 | (1, not(FBO)[0:52]), 1) |
| 1 | 0 | 0 | 0 | 0 | (0,FAO[0:52],0) |
| | 1 | 1 | 0 | −1 | (not(FAO[0:52]), 11) |

The reason for missing δ by 1 in the positive case is due to the one's complement subtraction of the exponents. This error term is compensated for in the Align 1 box.

2. SIGN_BIG is the sign bit of exponent difference δ. IS_BIG is a flag defined by:

$$IS\_BIG = \{ \begin{matrix}1 & if δ \geq 65 or δ \leq - 64 \\ 0 & otherwise\end{matrix}$$

3. In the big exponent difference intervals, the “required” alignment shift is at least 64 positions. Since all alignment shifts of 54 positions or more are equivalent (i.e., beyond the sticky-bit position), the shift amount may be limited in this case. In the Align 2 region one of the following alignment shift occurs: (a) a fixed alignment shift by 63 positions in case the exponent difference belongs to the big exponent difference intervals (this alignment ignores the pre-shifting altogether); or (b) an alignment shift by mag med positions in case the exponent difference belongs to the medium exponent difference interval.

4. In the One's Complement box, the signals FAO, FBO, and s.EFF are computed. The FAO and FBO signals are defined by

$$FAO [ 0 : 52 ] , FBO [ 0 : 52 ] = \{ \begin{matrix}FA [ 0 : 52 ] , FB [ 0 : 52 ] & if S . EFF = 0 \\ not ( FA [ 0 : 52 ] ) , not ( FB [ 0 : 52 ] ) & otherwise .\end{matrix}$$

5. The computations performed in the Pre-shift & Align 1 region are relevant only if the exponent difference is in the medium exponent difference interval. The significands are pre-shifted if an effective subtraction takes place. After the pre-shifting, an alignment shift by one position takes place if sign_med=1. Table 1 summarizes the specification of FSOP′[−9:53].

6. In the Swap region, the minuend is selected based on sign_big. The subtrahend is selected for the medium exponent difference (based on sign_med) interval and for the large exponent difference interval (based on sig_big).

7. The Pre-shift 2 region deals with pre-shifting the minuend in case an effective subtraction takes place.

The input to the second cycle consists of: the sign bit SL, a representation of the exponent el, the significand strings FLP[−1:52] and FSOPA[−1:116], and the rounding mode. Together with the sign bit SL, the rounding mode is reduced to one of the three rounding modes: RZ, RNE, or RI.

The output consists of the sign bit SL, the exponent string (the computation of which is not discussed here), and the normalized and rounded significand f-farε[1, 2) represented by F_FAR[0:52]. If the significand sum (after pre-shifting) is greater than or equal to 1, then the output of the second cycle of the R-path satisfies:

rnd(fsum)=rnd((−1)^{sl}·(flp+fsopa+S.EFF·2⁻¹¹⁶)) =(−1)^{sl} ·f−far

Note that in effective subtraction, 2⁻¹¹⁶ is added to correct the sum of the one's complement representations to the sum of two's complement representations by the lazy increment from the first clock cycle.

FIGS. 3A and 3B depict the partitioning of the computations in the 2nd cycle of the R-path into basic blocks and specifies the input- and output-signals of each of these basic blocks.

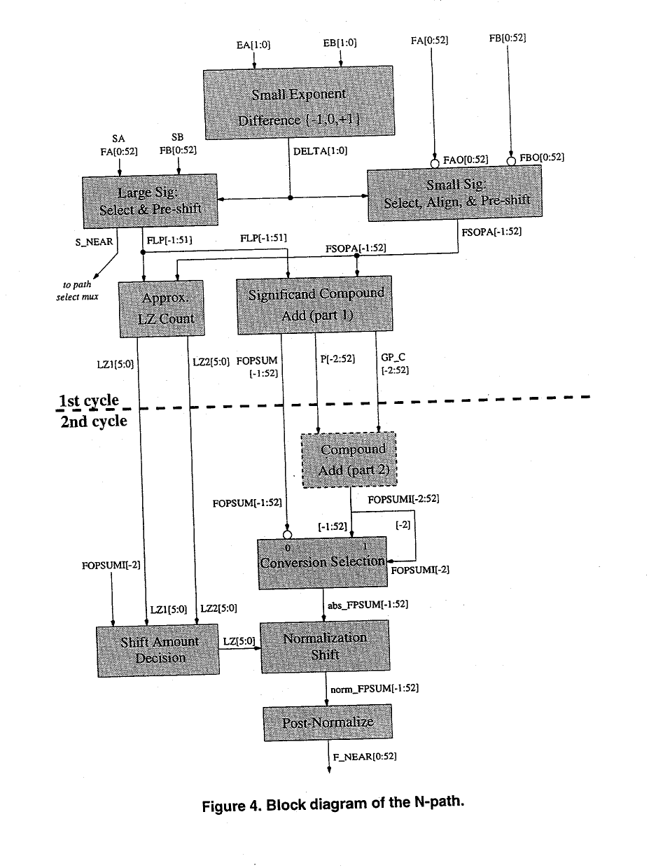

A block diagram of the N-path and the central signals are depicted in FIG. 4.

1. The Small Exponent Difference box outputs DELTA[1:0] which represents in two's complement the difference ea−eb.

2. The input to the Small Significands: Select, Align, & Pre-shift box consists of the inverted significand strings FAO and FBO. The selection means that if the exponent difference equals −1, then the subtrahend corresponds to FA, otherwise it corresponds to FB. The pre-shifting means that the significands are preshifted by one position to the left (i.e., multiplied by 2). The alignment means that if the absolute value of the exponent difference equals 1, then the subtrahend needs to be shifted to the right by one position (i.e., divided by 2). The output signal FSOPA is therefore specified by

$$FSOPA [ - 1 : 52 ] = \{ \begin{matrix}0 , FA [ 0 : 52 ] ) & if ea - ab = - 1 \\ ( FB [ 0 : 52 ] , 0 ) & if ea - eb = 0 \\ ( 0 , FB [ 0 : 52 ] ) & if ea - eb = 1.\end{matrix}$$

Note that FSOPA[−1:52] is the one's complement representation of −2·fs/2^{abs(ea-eb)}.

3. The Large Significands: Select & Pre-shift box outputs the minuend FLP[−1:51 and the sign-bit of the addend it corresponds to. The selection means that if the exponent difference equals −1, then the minuend corresponds to FB, otherwise it corresponds to FA. The pre-shifting means that the significands are preshifted by one position to the left (i.e., multiplied by 2). The output signal FSOPA is therefore specified by

$$FLP [ - 1 : 51 ] , SL = \{ \begin{matrix}FB [ 0 : 52 ] , SB & if ea - eb = - 1 \\ FA [ 0 : 52 ] , SA & if ea - eb \geq 0.\end{matrix}$$

Note that FLP[−1:51] is the binary representation of 2·fl. Therefore:

flp+fsopa=2(fl−fs/2^{abs(ea-eb)}) −2⁻⁵²=fpsum−2⁻⁵²

4. The Approximate LZ count box outputs two estimates, lzp1, lzp2 of the number of leading zeros in the binary representation of abs(fpsum). The estimates lzp1, lzp2 satisfy the following property:

−fpsum−2^{lzp1}ε[1, 4) if fpsum<0

fpsum−2^{lzp2}ε[1, 4) if fpsum>0.

5. The Shift Amount Decision box selects the normalization shift amount between lzp1 and lzp2 depending on the sign of the significand difference as follows:

$$lzp = \{ \begin{matrix}lzp1 & if fpsum < 0 \\ lzp2 & if fpsum > 0.\end{matrix}$$

6. The Significand Compound Add boxes, parts 1 and 2, together with the Conversion Selection box, compute the sign and magnitude of fpsum=flp+fsopa+2⁵². The magnitude of fpsum is represented by the binary string abs_FPSUM[−1:52] and the sign of the sum is represented by FOPSUMI[−2]. The method of how the sign and magnitude are computed was described above.

7. The Normalization Shift box shifts the binary string abs_FPSUM[−1:53] by lzp positions to the left, padding in zeros from the right. The normalization shift guarantees that norm_fpsum is in the range [1, 4).

8. The Post-Normalize outputs f_near that satisfies:

$$f\_near = \{ \begin{matrix}norm\_fpsum & if norm\_fpsum ∈ [ 1 , 2 ) \\ norm\_fpsum / 2 & if norm\_fpsum ∈ [ 2 , 4 )\end{matrix}$$

### Delay Analysis

The implementation of the preferred FP-adder is described in detail and an analysis of the delay of the FP-adder implementation in technology-independent terms (logic levels) is presented here. The delay analysis is based on various assumptions on delays of basic boxes [7], [23]. The implementation of the 1st stage and the 2nd stage of the R-Path, the implementation of the N-path, and the implementation of the path selection condition are described and analyzed separately.

FIGS. 5A and 5B depict a detailed block diagram of the first cycle of the R-path. The nonstraightforward regions are described below.

1. The Exponent Difference region is implemented by cascading a 7-bit adder with a 5-bit adder. The 7-bit adder computes the lazy one's complement exponent difference if the exponent difference is in the medium interval. This difference is converted to a sign and magnitude representation denoted by sign_med and mag_med. The cascading of the adders enables the evaluation of the exponent difference (for the medium interval) in parallel with determining whether the exponent difference is in the big range. The SIGN-BIG signal is simply the MSB of the lazy one's complement exponent difference. The IS-BIG signal is computed by OR-ing the bits in positions [6:10] of the magnitude of the lazy one's complement exponent difference. This explains why the medium interval is not symmetric around zero.

2. The Align 1 region depicted in FIG. 5B is an optimization of the Pre-shift & Align 1 region in FIG. 3A. The reader can verify that the implementation of the Align 1 region satisfies the specification of FSOP′ [−1:53] that is summarized in Table 1.

3. The following condition is computed during the computation of the exponent difference

IS_R1 [symbol] (|ea−eb|≧2)

[symbol]

ORtree(IS_BIG, MAG_MED[5:0], and(MAG_MED[0], not (SIGN_BIG))),

which will be used later for the selection of the valid path. Note that the exponent difference is computed using one's complement representation. This implies that the magnitude is off by one when the exponent difference is positive. In particular, the case of the exponent difference equal to 2 yields a magnitude of 1 and a sign bit of 0. This is why the expression and(MAG_MED[0], not(SIGN_BIG)) appears in the OR-tree used to compute the IS_R signal.

The annotation in FIGS. 5A and 5B depict the delay analysis of the preferred method. This analysis is based on the following assumptions:

1. The delay associated with buffering a fan-out of 53 is one logic level.

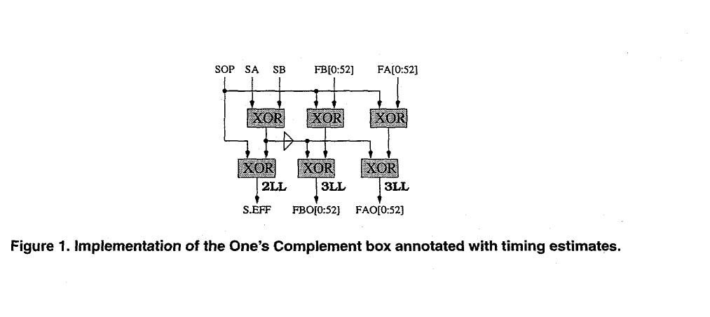

2. The delays of the outputs of the One's Complement box are justified in FIG. 1.

3. The delay of a 7-bit adder is 4 logic levels. Note that it is important that the MSB be valid after 4 logic levels. This assumption can be relaxed by requiring that bits [6:5] are valid after 4 logic levels and after that two more bits become valid in each subsequent logic level. This relaxed assumption suffices since the right shifter does not need all the control inputs simultaneously.

4. The delay of the second 5-bit adder is 5 logic levels even though the carry-in input is valid only after 4 logic levels. This can be obtained by computing the sum and the incremented sum and selecting the final sum based on the carry-in (i.e., carry select adder).

5. The delay of a 5-bit OR-tree is two logic levels.

6. The delay of the right shifter is 5 logic levels. This can be achieved by encoding the shift amount in pairs and using 4-1 muxes.

FIGS. 6A and 6B show a detailed block diagram of the 2nd cycle of the R-path. The details of the implementation are described below.

The implementation of the R-path in the 2nd cycle consists of two parallel paths called the upper part and the lower part. The upper part deals with positions [−1:52] of the significands and the lower part deals with positions [53:116] of the significands. The processing of the lower part has to take into account two additional values: the rounding injection, which depends only on the reduced rounding mode, and the missing ulp (2⁻¹¹⁶) in effective subtraction due to the one's complement representation.

The processing of FSOPA[53:116], INJ(53:116] and S.EFF 2⁻¹¹⁶ is based on:

$$\vert TAIL [ 52 : 116 ] \vert = \{ \begin{matrix}\vert FSOPA [ 53 : 116 ] \vert + \vert INJ [ 53 : 116 ] \vert & if \overline{S . EFF} \\ \vert FSOPA [ 53 : 116 ] \vert + \vert INJ [ 53 : 116 ] \vert + {2}^{- 116} & if \overline{S . EFF}\end{matrix}$$

The bits C[52], R′, S′ are defined by

S′=or(TAIL [541, TAIL (55], . . . , TAIL [116])

R′=TAIL[53]

C[52]=TAIL[52]

The bits S′, R′ and C[52] are computed by using a 2-bit injection string. Effective addition and effective subtraction are different.

1. Effective addition. Let S_{add} denote the sticky bit that corresponds to FSOPA[54:116], then

S_{add}=or(FSOPA[54], . . . , FSOPA[116]).

The injection can be restricted to two bits INJ[53:54] and a 2-bit addition is performed to obtain the three bits C[52], R′, S′:

|(C[52],R′,S′)=|INJ[53:54]|+|(FSOPA[53],S_{add})|

2. Effective subtraction. In this case, the missing 2-116 that was not added during the first cycle must be added to FSOPA. Let S_{sub} denote the sticky bit that corresponds to bit positions [54:116] in the binary representation of |FSOPA[54:116]|+2⁻¹¹⁶, then

S_{sub}=OR(NOT(FSOPA[54]), . . . , NOT(FSOPA[116]))=NAND(FS[54], . . . , FS[116])

The addition of 2⁻¹¹⁶ can create a carry to position [53] which is denoted by C[53]. The value of C[53] is one iff FSOPA [54:116] is all ones, in which case the addition of 2⁻¹¹⁶ creates a carry that ripples to position [53]. Therefore, C[53]=NOT(S_{sub}). Again, the injection can be restricted to two bits INJ[53:54], and C[52], R′, S′ is computed by adding

|C[52],R′,S′|=|(FSOPA[53+],S_{sub})|+|INJ[53:54]|+2C[53]

Note, that the result of this addition cannot be greater than 7-2⁻⁵⁴, because C[53]=NOT(S_{sub}).

A fast implementation of the computation of C[52], R′, S′ proceeds as follows. Let S=S_{add} in effective addition, and S=S_{sub} in effective subtraction. Based on S.EFF, FSOPA[53], and INJ[53:54], the signals C[52], R′, S′ are computed in two paths: one assuming that S=1 and the other assuming that S=0.

FIGS. 6A and 6B depict a naive method of computing the sticky bit S to keep the presentation structured rather than obscure it with optimizations. A conditional inversion of the bits of FSOPA[54:116] is performed by XOR-ing the bits with S.EFF. The possibly inverted bits are then input to an OR-tree. This suggestion is somewhat slow and costly. A better method would be to compute the OR and AND of (most of) the bits of FS[54:116] during the alignment shift in the first cycle. The advantages of advancing (most of) the sticky bit computation to the first cycle is twofold: (1) there is ample time during the alignment shift whereas the sticky bit should be ready after at most 5 logic levels in the second cycle; and (2) this saves the need to latch all 63 bits (corresponding to FS[54:116]) between the two pipeline stages.

The upper part computes the correctly rounded sum (including post-normalization) and uses for the computation the strings FLP[−1:52], FSOPA[−1:52], and (C[52], R′, S′). The rest of the algorithm is identical to the rounding algorithm presented, analyzed, and proven for FP multiplication in [7].

The annotation in FIGS. 6A and 6B depicts the delay analysis. This is almost identical to the delay analysis of the multiplication rounding algorithm cited above [7]. In this way, the 2nd cycle of the R-path implementation has a delay of 12 logic levels, so that the whole R-path requires a delay of 24 logic levels between the latches.

FIGS. 7A and 7B show a detailed block diagram of the N-path. The non-straightforward boxes are described below.

1. The region called “Path Selection Condition 2″ computes the signal IS_R2 which signals whether the magnitude of the significand difference (after pre-shifting) is greater than or equal to 1. This is one of the clauses need to determine if the outcome of the R-path should be selected for the final result.

2. The implementation of the Approximate LZ Count box deserves some explanation. (a) The PN-recoding creates a new digit in position [−2]. This digit is caused by the negative and positive carries. Note that the P-recoding does not generate a new digit in position [−3]. (b) The PENC boxes refer to priory encoders; they output a binary string that represents the number of leading zeros in the input string. (c) How is LZP2(5:0) computed? Let k denote the number of leading zeros in the output of the 55-bitwise XOR. Proposition 1 implies that if flp+fsopa>0, then (flp+fsopa)·2^{k} ε[1, 4). The reason for this (using the terminology of Proposition 1) is that the position of the digit σ equals [k−2]. σ is brought to position [−2] in the present method (recall that an additional multiplication by 4 is used to bring the positive result to the range [1, 4)). Hence a shift by k positions is required and LZP2 [5:0] is derived by computing k. (d) How is LZP1 [5:0] computed? If flp+fsopa<0, then Proposition 1 implies that (flp+fsopa)·2^{k-1} ε[1, 4). The reason for this is that σ is brought to position [−1] (recall that an additional multiplication by 2 is used to bring the negative result to the range [1, 4)). Hence a shift by k−1 positions is required and LZP 1 [5:0] is computed by counting the number of leading zeros in positions [−1:52] of the outcome of the 55-bitwise XOR.

For the N-path, the timing estimates are annotated in the block diagram in FIGS. 7A and 7B. Corresponding to this delay analysis, the latest signals in the whole N-path are valid after 21 logic levels, so that this path is not time critical. The delay analysis depicted in FIGS. 7A and 7B suggests two pipeline borders: one after 12 logic levels, and another after 13 logic levels. As discussed above, a partitioning after 12 logic levels requires to partition the implementation of the compound adder between two stages. This can be done with the implementation of the compound adder discussed above, so that a first stage of the N-path that is valid after 12 logic levels and a second stage of the N-path, where the signals are valid after 9 logic levels. This leaves some time in the second stage for routing the N-path result to the path selection mux in the R-path.

Selection between the R-path and the N-path result depends on the signal IS_R. The implementation of this condition is based on the three signals IS_R1, IS_R2, and S.EFF, where IS_R1 [symbol] (abs(delta)≧2) is the part of the path selection condition that is computed in the R-path, and IS_R2 is the part of the path selection condition that is computed in the N-path. With the definition of IS-RI, it follows from Eq. 1 that:

IS_{—}R=\overline{S.EFF} [symbol] IS_{—}R1 [symbol] (fpsum ε[2,4)) =\overline{S.EFF} [symbol] IS_{—}R1 [symbol] ((fpsum ε[2,4)) AND S.EFF AND \overline{IS_{—}R1}).

Define IS_R=(fpsum ε[2,4)) [symbol] S.EFF [symbol] \overline{IS_R1}, so that IS_R=\overline{S.EFF} [symbol] IS_R1 [symbol] IS_R2.

Because the assumptions S.EFF=1 and _{{overscore (S_{_{—}}_{R})}} are exactly the assumptions used during the computation of fpsum in the N-path, the condition IS_R2 is easily implemented in the N-path by the bit at position [−1] of the absolute significand difference. The condition IS-R1 and the signal S.EFF are computed in the R-path. After IS_R is computed from the three components according to equation 4, the valid result is selected either from the R-path or the N-path accordingly. Because the N-path result is valid a few logic levels before the R-path result, the path selection can be integrated with the final rounding selection in the R-path. Hence, no additional delay is required for the path selection and the overall implementation of the floating-point adder can be realized in 24 logic levels between the pipeline stages.

### Verification and Testing

The preferred method of FP addition and subtraction described above was verified and tested. Detailed results are set forth in [2]. In that paper, the following novel methodology was used. Two parametric algorithms for FP-addition were designed, each with p bits for the significand string and n bits for the exponent string. One algorithm is the naive algorithm, and the other algorithm is the preferred method of FP addition described above. Small values of p and n enable exhaustive testing (i.e., input all 2·2^{p+n+1} binary strings). This exhaustive set of inputs was simulated on both algorithms. Mismatches between the results indicated mistakes in the design. The mismatches were analyzed using assertions specified in the description of the algorithm, and the mistakes were located. Interestingly, most of the mistakes were due to omissions of fill bits in alignment shifts. The preferred method of FP addition described above paper passed this verification without any errors. The algorithm was also extended to deal with denormal inputs and outputs [1], [22].

To overview the designs from other FP-adder implementations (see [3], [6], [8], [9], [10], [12], [13], [14], [15], [16], [17], [18], [19], [20], [21], [22], [23], [24], [25], and [27]), a summary of the optimization techniques that were used in each of the implementations is listed in Table 2. The entries in Table 2 are ordered from top to bottom corresponding to the year of publication.

The last two entries in this list correspond to the preferred method of FP addition, where the bottom-most entry is assumed to use an additional optimization of the alignment shift in the R-Path to be implemented by duplicating the shifter hardware and to use one shifter when δ>0 and the other shifter when δ<0. On the one hand this optimization has the additional cost of more than a 53-bit shifter. On the other hand it can save one logic level in the latency of the preferred implementation, resulting in 23 logic levels. Even with this optimization the preferred method is to partition into two pipeline stages with 12 logic levels between latches, although the first stage then only requires 11 logic levels.

Although many designs use two paths for the computations, in many cases these two paths actually refer to one path with a simplified alignment shift and another path with a simplified normalization shift, without the need to complement the significand sum as originally suggested in [8]. In some cases the two paths are just used for different rounding cases. In other cases, rounding is not dealt within the two paths at all, but computed in a separate rounding step that is combined for both paths after the sum is normalized. These implementations can be recognized in Table 2 by the fact that they do not pre-compute the possible rounding results and only have to consider one result binade to be rounded.

Among the “two-path” implementations from literature there are primarily three different path selection conditions:

The first group uses the “original” path selection condition from [8], which is only based on the absolute value of the exponent different. A “far”-path is then selected for |δ|>1 and a “near”-path is selected for |δ|≦1. This path selection condition is used by the implementations from [3, 14, 18, 21, 23]. All of them have to consider four different result binades for rounding.

A second version of the path selection condition is used by [17]. In this case the far path is additionally used for all effective additions. This allows unconditionally negatation of the smaller operand in the “near”-path. Also this implementation has to consider four different result binades for rounding.

In the implementation of [10], a third version of the path selection condition is used. In this case, additionally, the cases where only a normalization shift by at most one position to the right or one position to the left are computed in the “far”-path. In this way, the design could get rid of the rounding in the “near”-path. Still there are three different result binades to be considered for rounding and normalization in the “far”-path of this implementation.

The path selection condition of the preferred method is different from these three methods. Its advantages were described above. In the path selection of the preferred method, no additions and no rounding has to be considered in the “near” path. In addition, the number of binades that have to be considered for rounding and normalization in the “far” path is reduced to two. As described above, there is a very simple implementation for the path selection condition in the preferred method that only requires very few gates to be added in the R-path.

Besides the implementation in “two paths,” the optimization techniques most commonly used in previous designs are: (1) the use of one's complement negation for the significand, (2) the parallel pre-computation of all possible rounding results in an upper and a lower part, and (3) the parallel approximate leading zero count for an early preparation of the normalization shift. Especially for the leading zero approximation, there are many different implementations suggested by others. The main difference of the preferred method for leading zero approximation is that the preferred method operates on a borrow-save encoding with Recodings. The correctness of the preferred method can be proven very elegantly based on bounds of fraction ranges.

Two of the implementations that are summarized in Table 2 are chosen and described in more detail below: (1) an implementation based on U.S. Pat. No. 6,094,668 (hereinafter “the AMD patent”); and (2) an implementation based on U.S. Pat. No. 5,808,926 (hereinafter “the SUN patent”). The union of the optimization techniques used by these two implementations to reduce delay form a superset of the main optimization techniques from previously published designs. The preferred method described above adds some additional optimization techniques to reduce delay and to simplify the design, as pointed out in Table 2. Therefore, it is likely that the designs of the AMD and SUN patents are the fastest implementations that were previously published. For this reason these designs have been chosen to analyze and compare with the preferred method of the present invention. Although other designs address other issues, e.g., reducing cost by sharing hardware between the two paths, or following the pipelined-packet forwarding paradigm, these implementations are not optimized for speed and do not belong to the fastest designs. Therefor, they were not included in this study.

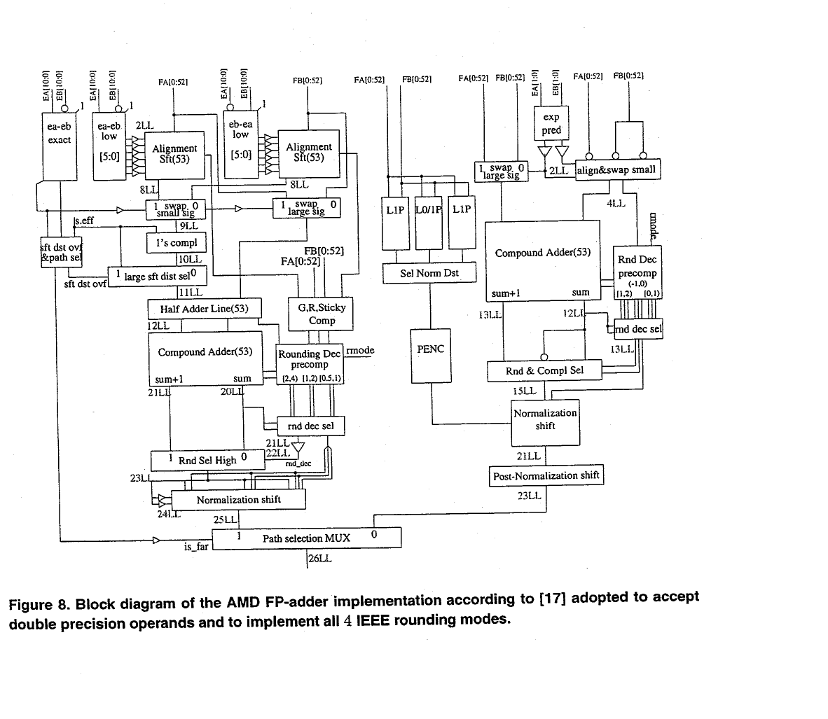

The AMD patent from describes an implementation of an FP-adder for single precision operands that only considers the rounding mode round to nearest up. To be able to compare this design with the preferred method of the present invention, the design was extended to double precision and hardware was added for the implementation of the four IEEE rounding modes. The main changes that were required for the IEEE rounding implementation was the “large shift distance selection”-mux in the “far”-path to be able to deal also with exponent differences |δ|>63. Then, the half adder line, in the far path before the compound adder, had to be added to be able also to pre-compute all possible rounding results for rounding mode round-to-infinity. Moreover, some additional logic had to be used for a L-bit fix in the case of a tie in rounding mode round-to-nearest in order to implement the IEEE rounding mode RNE instead of RNU. FIGS. 8A and 8B show a block diagram of the adopted FP-adder implementation based on the AMD patent. This block diagram is annotated with timing estimates in logic levels. These timing estimates were determined along the same lines as in the delay analysis of the preferred FP-adder implementation. In this way the analysis suggests that the adopted AMD patent implementation has a delay of 26 logic levels.

One main optimization technique in the AMD patent design is the use of two parallel alignment shifters at the beginning of the “far”-path. This technique makes it possible to begin with the alignment shifts very early, so that the first part of the “far”-path is accelerated. On this basis, the block diagram 8 suggests to split the first stage of the “far”-path after 11 resp.-12 logic levels, leaving 15 resp.-14 logic levels for a second stage. Thus, the design is not very balanced for double precision and it would not be easy to partition the implementation into two clock cycles that contain 13 logic levels between latches.

In the last entry of Table 2, the technique using two parallel alignment shifters was considered in the method of the present invention. Because the first stage of the R-path could be reduced to 11 logic levels in this case, a total latency of 23 logic levels could be obtained for this optimized version of the preferred method.

The SUN patent describes an implementation of an FP-adder for double precision operands considering all four IEEE rounding modes. The SUN patent also considers the unpacking of the operands, denormalized numbers, special values and overflows. The implementation targets a partitioning into three pipeline stages. For the comparison with the preferred method and the adopted AMD patent implementation, the functionality of the SUN patent implementation was also reduced to consider only normalized double precision operands. All additional hardware that was only required for the unpacking or the special cases was eliminated.

As discussed above, the FP-adder implementation corresponding to the SUN patent uses a special path selection condition that simplifies the “near”-path by getting rid of effective additions and the rounding computations. In this manner, the implementation of the “near”-path and the N-path implementation of the present invention are very similar. There are only some differences regarding the implementation of the approximate leading zero count and regarding the possible ranges of the significand sum that have to be considered.

Additionally, in the preferred embodiment, unconditional pre-shifts for the significands in the N-path are employed that do not require any additional delay.

In the “far”-path it is the main contribution of the SUN patent implementation to integrate the computation of the rounding decision and the rounding selection into a special CP adder implementation. On the one hand this simplifies to partition this design into three pipeline stages like suggested in the patent, because this modified CP adder design can be easily split in the middle. In the SUN patent, the delay of the modified CP adder implementation is estimated to be the delay of a conventional CP adder plus one additional logic level. The implementation of the path-selection condition seems to be more complicated than in other design and is depicted in the SUN patent by two large boxes to analyze the operands in both paths.

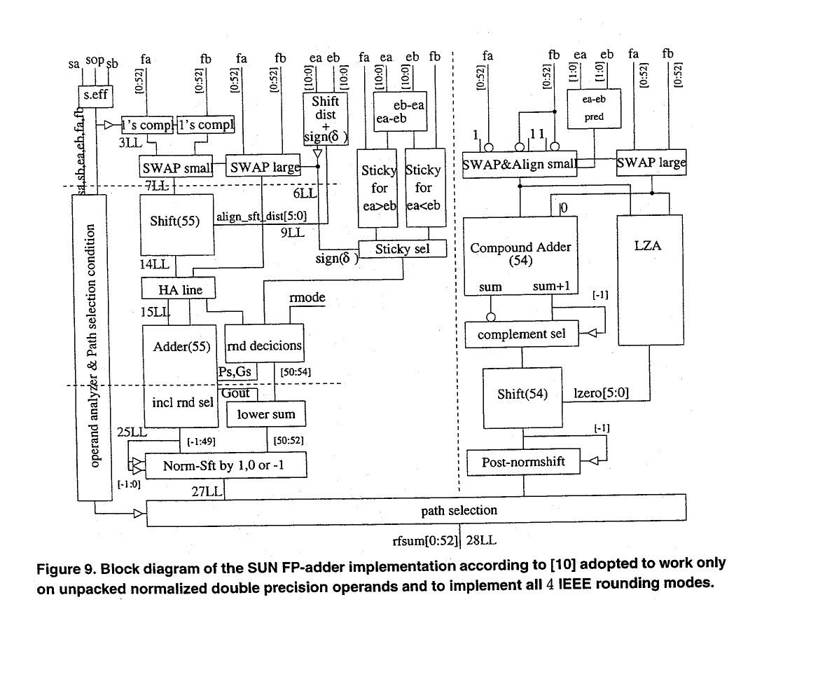

FIGS. 9A and 9B show a block diagram of this adopted design. These figures are annotated with timing estimates. For this estimate the modified CP adder is assumed to have a delay of 10 logic levels as discussed above. In this way, the delay analysis suggests that the adopted FP-adder implementation corresponding to the SUN patent has a delay of 28 logic levels. In this case the implementation of the first stage is not very fast and requires 14 logic levels.

Thus, in comparison with the preferred method of the present invention, the FP-adder implementations corresponding to the AMD patent and the SUN patent both seem to be slower by at least two logic levels. Additionally, they have a more complicated IEEE rounding implementation and can not as easily be partitioned into two balanced stages as the method of the present invention. Because the two implementations were chosen to be the fastest from the literature, the preferred FP-adder implementation seems to be the fastest published to date.

TABLE 2
Overview of optimization techniques used by different FP-adder implementations.

| | | | | | | | | modified |
|---|---|---|---|---|---|---|---|---|
| | two | | only | | | one's | | adder |
| | parallel | # CP | subtraction | no rounding | pre-computation | complement | parallel | including |
| | computation | adders for | in one of | required in | of rounding | significand | approx lead | round |
| implementation | paths | significands | the two paths | one path | results | negation | 0/1 count | decision |
| naive design (sec 3) | — | 1 | — | — | — | — | — | — |
| Farmwald ′87 [9] | — | 1 | — | — | — | — | — | — |
| INTEL ′91 [24] | — | 2 | — | — | X | X | X | — |
| Toshiba ′91 [12] | — | 2 | — | — | X | X | — | — |
| Stanford Rep ′91 [21] | X | 1 | — | — | — | — | — | — |
| Weitek ′92 [15] | X | 2 | — | — | — | X | — | — |
| NEC ′93 [14] | X | 3 | — | — | X | — | X | — |
| Park et al ′96 [19] | — | 1 | — | — | X | X | — | — |
| Hitachi ′97 [27] | — | 1 | — | — | — | X | X | — |
| SNAP ′97 [18] | X | 2 | — | — | X | X | X | — |
| Seidel/Even ′98 [23] | X | 2 | — | — | X | X | X | — |
| AMD ′98 [25] | X | 4 | — | — | — | — | X | — |
| IBM ′98 [6] | X | 2 | — | — | — | X | — | — |
| SUN ′98 [10] | X | 2 | X | X | X | X | X | X |
| NEC ′99 [13] | — | 1 | — | — | — | — | X | — |
| Adelaide ′99 [3] | X | 2 | — | — | X | X | X | — |
| AMD ′00 [17] | X | 2 | X | — | X | X | X | — |
| Seidel/Even ′00 (sec5) | X | 2 | X | X | X | X | X | — |
| Seidel/Even ′00* | X | 2 | X | X | X | X | X | — |

| | injection- | unification | | one's | split of | | | latency (in |
|---|---|---|---|---|---|---|---|---|
| | based | of rounding | pre-computation | complement | δ in | two alignment | # binades | LL) for |
| | rounding | cases | of post- | exponent | upper and | shifters for | to consider | double |
| implementation | reduction | for add/sub | normalization | difference | lower half | δ ≦ 0 & δ < 0 | for rounding | precision |
| naive design (sec 3) | — | — | — | — | — | — | 1 | >42 |
| Farmwald ′87 [9] | — | — | — | — | — | — | 1 | |
| INTEL ′91 [24] | — | — | — | — | — | — | 3 | |
| Toshiba ′91 [12] | — | — | — | — | — | — | 3 | |
| Stanford Rep ′91 [21] | — | — | — | — | — | — | 3 | |
| Weitek ′92 [15] | — | — | — | — | — | — | 1 | |
| NEC ′93 [14] | — | — | — | — | — | — | 4 | |
| Park et al ′96 [19] | — | — | — | — | — | — | 3 | |
| Hitachi ′97 [27] | — | — | — | — | — | — | 1 | |
| SNAP ′97 [18] | — | — | — | — | — | — | 4 | >28 |
| Seidel/Even ′98 [23] | X | X | X | X | X | — | 3 | 24 |
| AMD ′98 [25] | — | — | — | — | — | — | 1 | |
| IBM ′98 [6] | — | — | — | — | — | — | 1 | |
| SUN ′98 [10] | — | — | — | — | — | — | 3 | 28 |
| NEC ′99 [13] | — | — | — | — | — | — | 1 | |
| Adelaide ′99 [3] | — | — | — | — | — | — | 4 | >28 |
| AMD ′00 [17] | — | — | — | — | — | X | 4 | 26 |
| Seidel/Even ′00 (sec5) | X | X | X | X | X | — | 2 | 24 |
| Seidel/Even ′00* | X | X | X | — | — | X | 2 | 23 |

1. An apparatus for performing an arithmetic operation using first and second floating point numbers, comprising:
a first calculator configured to perform a first operation on the first and second floating point numbers to produce a first result;
a second calculator configured to perform a second operation on the first and second floating point numbers to produce a second result; and
a selector configured to select and output the first result when (1) the arithmetic operation and respective signs of the first and second floating point numbers indicate an effective arithmetic operation of subtraction, (2) a difference between respective significands of the first and second floating point numbers is in a predetermined range, and (3) an absolute value of a difference between respective exponents of the first and second floating point numbers is less than a predetermined value, and otherwise to select and output the second result.

2. The apparatus of claim 1, wherein the first calculator comprises:
a first subtractor configured to calculate the difference between the respective exponents of the first and second floating point numbers;
an aligning and swapping device configured to determine a largest of the first and second floating point numbers and to align bits of the respective significands of the first and second floating point numbers based on a result of the first subtractor;
an adder configured to calculate a sum of significands produced by the aligning and swapping device;
a leading-zero estimator configured to estimate a number of leading zeros based on the significands produced by the aligning and swapping device;
a leading zero selector configured to select a number of leading zeros based on a result of the leading-zero estimator and a result of the adder;
a converter configured to compute an absolute value of the result of the adder; and
a normalizing element configured to normalize the absolute value based on a result of the leading zero selector to produce the first result, whereby said first operation is performed.

3. The apparatus of claim 1, wherein the second calculator comprises:
a first subtractor configured to calculate the difference between the respective exponents of the first and second floating point numbers;
a negating element configured to negate the respective significands of the first and second floating point numbers;
a first aligning element configured to preshift and align the respective significands based on the effective arithmetic operation and a result of the first subtractor;
a swapping element configured to select, among results of the first aligning element, a minuend significand and a subtrahend significand, based on the result of the first subtractor;
a second aligning element configured to align the subtrahend significand based on the result of the first subtractor;
a first computing element configured to compute a least significant bit of a difference between the minuend and subtrahend significands;
a second computing element configured to compute remaining bits of the difference between the minuend and subtrahend significands;
a normalizing element configured to normalize a result of the second computing element; and
a rounding element configured to round a result of the normalizing element to produce the second result, whereby said second operation is performed.

4. An method for performing an arithmetic operation using first and second floating point numbers, comprising:
performing a first operation on the first and second floating point numbers to produce a first result;
performing a second operation on the first and second floating point numbers to produce a second result; and
selecting and outputting the first result when (1) the arithmetic operation and respective signs of the first and second floating point numbers indicate an effective arithmetic operation of subtraction, (2) a difference between respective significands of the first and second floating point numbers is in a predetermined range, and (3) an absolute value of a difference between respective exponents of the first and second floating point numbers is less than a predetermined value, and otherwise selecting and outputting the second result.

5. The method of claim 4, wherein the step of performing the first operation comprises:
calculating the difference between the respective exponents of the first and second floating point numbers;
determining a largest of the first and second floating point numbers and aligning bits of the respective significands of the first and second floating point numbers based on the difference between the respective exponents of the first and second floating point numbers;
summing significands determined in the determining step;
estimating a number of leading zeros based on the significands determined in the determining step;
selecting a number of leading zeros based on a result of the estimating step and a result of the summing step;
computing an absolute value of the result of the summing step; and
normalizing the absolute value based on a result of the selecting step to produce the first result.

6. The method of claim 4, wherein the step of performing the second operation comprises:
calculating the difference between the respective exponents of the first and second floating point numbers;
negating the respective significands of the first and second floating point numbers;
aligning and preshifting the significands based on the effective arithmetic operation and the difference between the respective exponents of the first and second floating point numbers;
selecting, among results of the aligning step, a minuend significand and a subtrahend significand, based on the difference between the respective exponents of the first and second floating point numbers;
realigning the subtrahend significand based on the difference between the respective exponents of the first and second floating point numbers;
computing a least significant bit of a difference between the minuend and subtrahend significands;
computing remaining bits of the difference between the minuend and subtrahend significands;
normalizing the remaining bits of the difference between the significands computed in the previous computing step; and
rounding a result of the normalizing step to produce the second result.
